(19) United States
(12) Patent Application Publication
(10) Pub. No.: US 2024/0223636 A1
(43) Pub. Date: Jul. 4, 2024

(54) STATISTICAL METHOD FOR DETERMINING QUALITY OF SERVICE WITH REDUNDANT RTP STREAMS OVER MOBILE NETWORKS

(71) Applicant: Clevon AS, Viljandi (EE)

(72) Inventors: Toomas Kadarpik, Haapsalu (EE); Martin Appo, Pööritsa village (EE); Marko Soomets, Tartu (EE)

(21) Appl. No.: 18/398,743

(22) Filed: Dec. 28, 2023

Related U.S. Application Data
(60) Provisional application No. 63/477,876, filed on Dec. 30, 2022.

(51) Int. Cl. H04L 65/65; H04L 65/80; H04W 28/02

(52) U.S. Cl. CPC H04L 65/65; H04L 65/80; H04W 28/0268

(57) ABSTRACT

Systems and methods for determining and managing video streaming quality over 4G/LTE/5G networks, and in particular, a method for determining and managing the Quality of Service (QOS) on a receiver side. This disclosure provides solutions to provide a stable, reliable, real-time and high-quality video stream over multiple 4G/LTE/5G networks in order to improve the TeleOperation functionality of automated vehicles. The method of evaluating video stream and network quality and dynamically adjusting the video bandwidth offer a more reliable stream between the sender and the receive, thus providing for superior control of automated vehicles.

### PRIORITY

This application claims priority to U.S. provisional patent application 63/477,876 filed on Dec. 30 2022.

### BACKGROUND

Autonomous Vehicles (AV) have been under development for a few decades by now. Although there are already multiple fleets deployed in different metropolitan areas to serve as robotaxis, we cannot say that they are completely and 100% autonomous. According to Society of Automotive Engineers (SAE) driving automation is classified from level 0 to level 5; level 0 is a manual system where a human performs all the driving tasks; level 5 is full automation where the vehicle performs all driving tasks under all conditions. In level 5 no human attention or interaction is required. Level 4 Driving Automation is referred to as high-driving automation, not full-automation, meaning that there still must be a human in the loop. Here the TeleOperation (TO) functionality becomes a relevant issue: TO enables a human to be in the control or in a loop of decision making of the vehicle from a remote location.

Generally, the TO functionality relies on network connectivity in order to enable interaction between Control Station (CS) and the Vehicle. The communication includes controls from CS to Vehicle, feedback from the Vehicle and video stream from the Vehicle. Most of the network bandwidth and processing complexity goes under a video stream. The stream must be real-time, stable and high-quality in order for it to be useful for safe and efficient teleoperation. The connectivity relies on the 4G/LTE/5G network that may not be stable in every geographical position of an operating area.

4G/LTE/5G networks are usually quite unpredictable as the number of users and the overall load of a single mobile cell can vary. In case of a moving teleoperated vehicle the video stream is a crucial part of the service itself as it needs to be as good as possible for the teleoperator to control the vehicle to the best of their ability. Accordingly, there is a need for a stable, reliable, real-time and high-quality video stream over multiple 4G/LTE/5G networks.

### SUMMARY

This disclosure provides solutions to provide a stable, reliable, real-time and high-quality video stream over multiple 4G/LTE/5G networks in order to improve the TeleOperation functionality of AVs. Compared to single-channel static bandwidth video streaming, the method of evaluating video stream and network quality and adjusting the video bandwidth dynamically is provided to offer a more reliable stream. The solution described is equally applicable to other wireless and/or mobile networks.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other.

Like reference numerals designate corresponding parts throughout the several views.

FIG. 1 illustrates an example system that includes an automated vehicle and an operating site in accordance with certain implementations of the disclosure;

FIG. 2 shows the measurement;

FIG. 3 illustrates the Main video an QoS flow;

FIG. 4. illustrates the flow within and between Sender and Receiver;

FIG. 5 shows the RTP packet header; and

FIG. 6 shows high level method flow schematic.

FIG. 7 shows an example, non-limiting, computing environment in which example embodiments and aspects may be implemented.

### DETAILED DESCRIPTION

The present disclosure generally relates to video streaming over 4G/LTE/5G networks, and in particular, a method for estimating the Quality of Service (QOS) on the receiver side. 4G/LTE/5G networks are usually quite unpredictable as the number of users and the overall load of a single mobile cell can vary. In case of a moving teleoperated vehicle the video stream is a crucial part of the service itself as it needs to be as good as possible for the teleoperator to control the vehicle to the best of their ability. RTP (Real-time Transport protocol) RFC 3550 defines the handling of streaming media commonly used for voice, video, telephony and the like. The present disclosure provides an improved method to determine the current maximum video quality, which can be modified by the sender, in a 4G/LTE/5G network with an unknown throughput, thus advancing the state of the art of teleoperated vehicles and other systems that utilize streaming media over mobile networks.

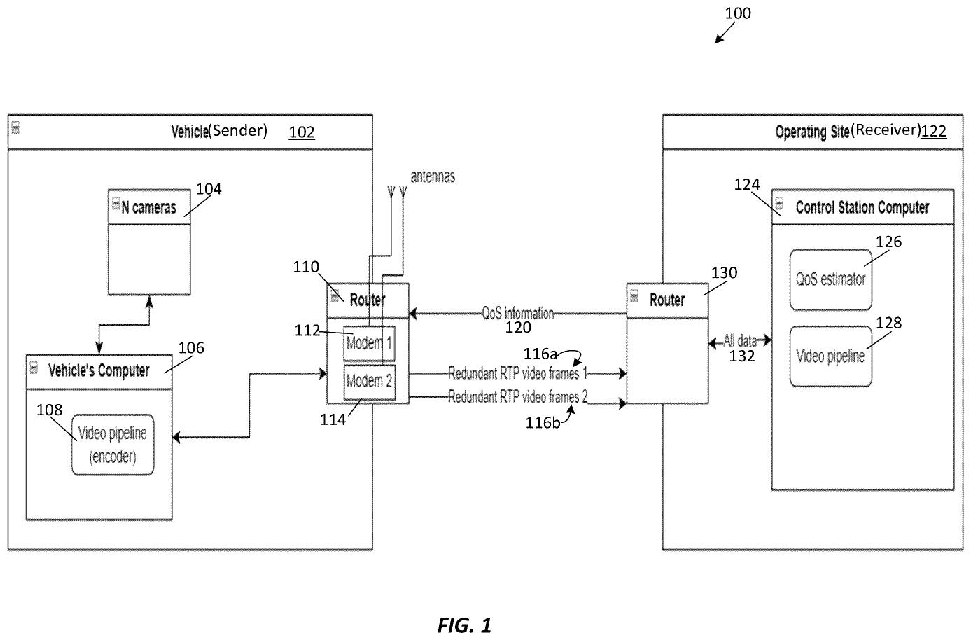

As is shown in FIG. 1, there is illustrated an example system 100 that includes an automated vehicle 102 and an operating site 122 in accordance with certain implementations of the disclosure. The implementations herein are described in the context of a video sender and a receiver. Here, the sender is the vehicle 102 and receiver is a Control Station (CS) 124 within the operating site 122. For both, there is a gateway router 110 and 130, through which all the communication (e.g., data 132) takes place. Additionally, relevant physical elements required in the vehicle are cameras 104, which are perceiving and providing the video data, as well as computer(s) 106 and 124 for conducting all processing. The gateway router 130 on the Control Station side 124 is shared with other Control Stations. The Operating Site (OS) 122 is a place where multiple CSs can be positioned.

As shown in FIG. 1, the system 100 further may include a vehicle computer 106, a video encoder 108, duplicated RTP video streams 116a and 116b for redundancy and a mechanism to receive QoS messages 120 on the sender side. The receiver side receives the RTP video streams, reorder and buffer the RTP packets as needed, dropping the duplicate packets which are not needed and send a QoS message to the sender based on current health of the incoming video streams.

The present disclosure deals with RTP which is based on UDP, a connectionless protocol. UDP is a simple transmission protocol defined in RFC 768 without guarantees for packet ordering, or data integrity as the UDP datagrams may arrive out of order, appear duplicated, or go missing.

A video pipeline (encoder) 108 within the vehicle computer 106 on the sender side encodes the video while defining the bitrate, modifying the overall quality and detail of the video, and transfers it, via modem 1 112 and modem 2 114 over two redundant channels, wirelessly over a 4G/LTE/5G network where they are received at a router 130 on the receiver side.

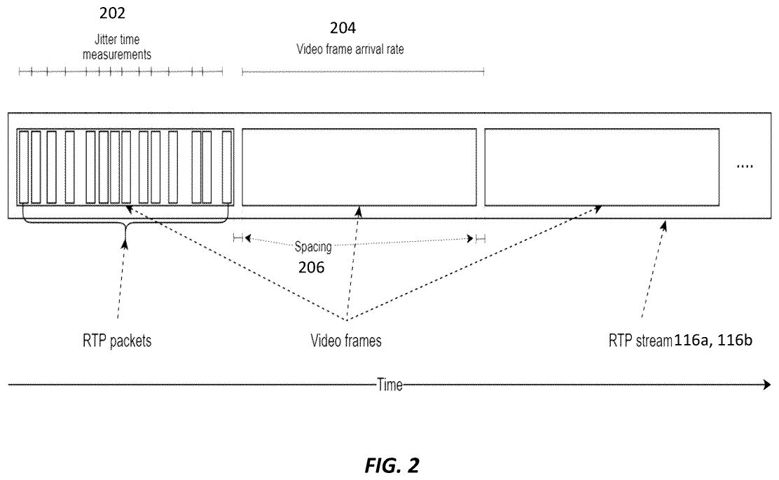

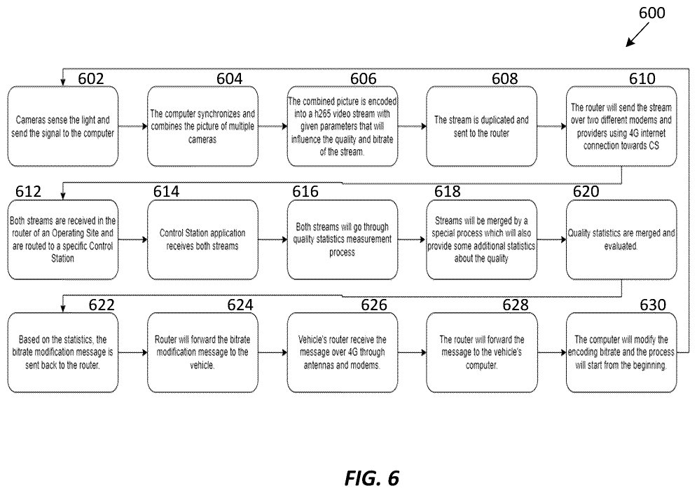

With reference to FIG. 2, the receiver monitors both incoming RTP streams 116a and 116b separately, over a set period of time, calculating the packet arrival jitter 202 within one video frame, current video frame arrival rate 204 using the time between the last frame's first packet and the next frame's first packet and the spacing 206 between previous frame's last packet and the next frame's first packet using the timestamps provided by the RTP packet header (see, FIG. 5). A packet count within a single video frame is unknown as with the current solution the receiver side does not know the current bitrate of the video. Once the set period of time passes, the current values of the calculated parameters are passed to a QoS estimator 126 to make a QoS decision. The QoS decision takes into account the previous parameter value while giving more weight to the latest values. The receiver side has a RTP jitter buffer 406 that handles the reordering of the packets. In case of missing packets, a maximum latency is set for one incoming frame before it is forwarded to a video decoder 404. The jitter buffer 406 provides additional information to the QoS algorithm when a video frame has missing packets.

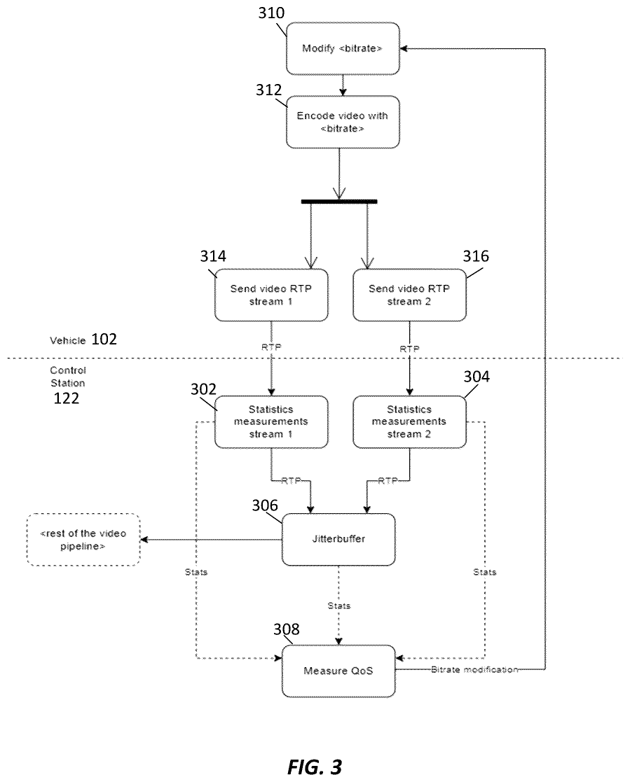

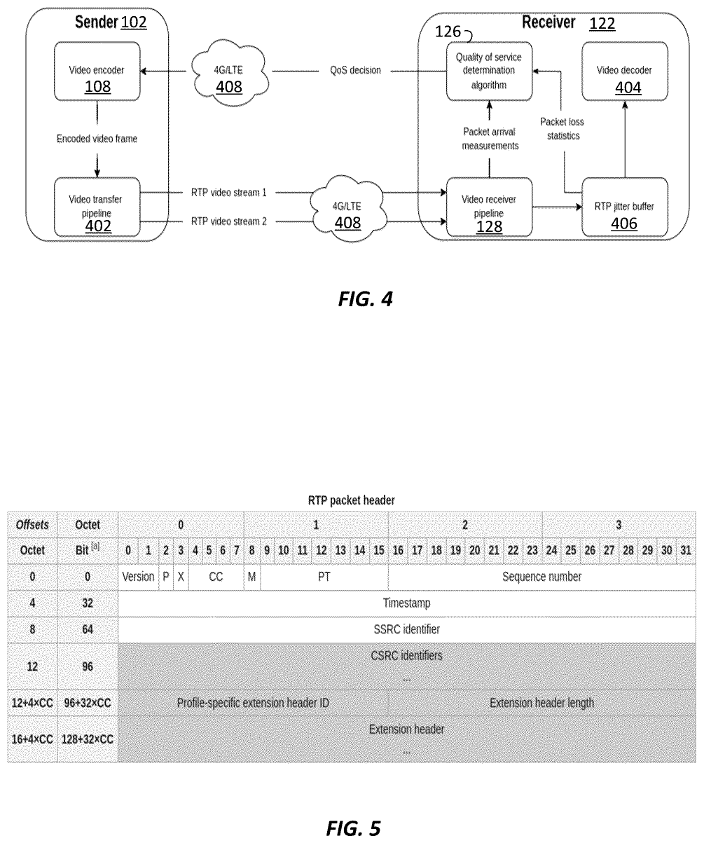

With reference to FIGS. 3 and 4, there are three separate QoS decisions made by the QoS estimator 126: “increase,” “reduce,” or “stay.” “Increase” and “reduce” actions send a command to the sender side to increase or reduce the current video bitrate respectively. The “stay” action maintains a video bitrate and does nothing when the current stream seems stable, and no further actions are needed.

With regard to adjusting the video bitrate, the QoS estimator 126 first determines (at 302 and 304) whether one of the streams' (116a or 116b) is excellent based on the stream jitter and frame spacing (306), in this case only one of the streams is deemed stable enough to increase the current bitrate as the stream reliability is high enough that redundancy is not needed in this case. Next, at 308, the receiver 122 determines whether the incoming streams are synchronized to provide redundancy. For this, the packet arrival rate is used as the video stream's frames per second is known. If the arrival rate of both streams is within an allowed deviation change rate, the streams are considered to be synchronized and the algorithm continues with further checks. The following mathematical model may be used define the deviation change and rate (k), where the deviation change rate is defined as derivative of the packet jitter deviation function ƒ_{deviation}

$$KPI = \frac{d}{d t} {f}_{deviation} > k$$

By monitoring the KPI, or deviation change rate, precisely the transmission channel quality can be predicted to retain a high quality communication link.

Otherwise, a “reduce” QoS action is issued by the QoS estimator 126 (i.e., a Bitrate modification) and forwarded to the sender 102 to modify the bitrate at 310. This is because a single stream may not be reliable enough and the duplicated streams are not providing redundancy. Afterwards frame spacing of both streams is compared against previously predetermined ranges. If both the streams are within acceptable spacing range an “increase” QoS decision is made (i.e., a Bitrate modification) and forwarded to the sender 102 to modify the bitrate at 310. Otherwise, the algorithm falls back to the “stay” action. As a result, of the modification at 310, the sender encodes video accordingly at 312 (using video encoder 108), which is forwarded to the receiver 122 as RTP streams 116a, 116b at 314 and 316, respectively, using video pipeline 402. The QoS mechanism of FIG. 3, may be triggered asynchronously by the jitter buffer 406 to create a reduce decision in case of packet loss over both RTP streams.

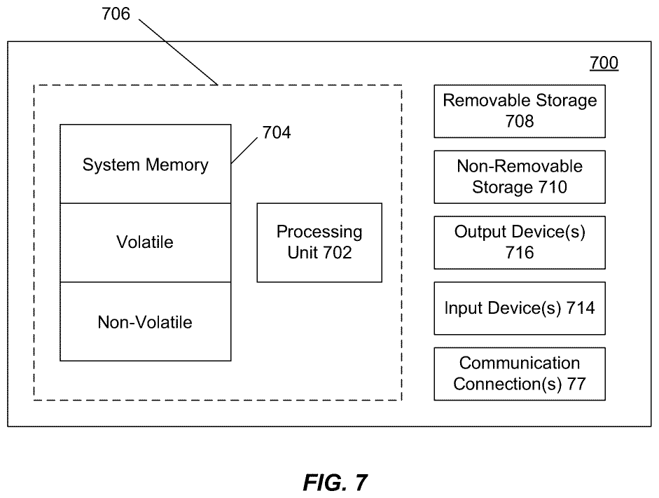

FIG. 6 illustrates an example method 600 in accordance with the present disclosure. At 602, camera senses the light and sends the signals to the computer. Within the vehicle, the cameras are perceiving and providing the video data and the computing device (also known as computer(s)), where all the processing is conducted. For example, the cameras are placed in a circular manner to stitch together a 360-degree view of their environment and can distinguish details of the surrounding environment. In a preferred embodiment the cameras are automotive wide-angle cameras with image sensors, and each vehicle camera is equipped with a camera washing system. When visibility through the lens is disturbed, it can be sprayed with washing liquid to clean the field of view. The computing device may be a general-purpose computer, such as shown in FIG. 7, having a computer-readable memory with instructions and a processor executing those instructions, that effects communications with the server, and initiates commands to operate the autonomous vehicle (AV). The AV may further include a second computing device that controls opening and closing of the cargo box and other mechanical components inside the cargo box located on top of the vehicle. The second computing device may receive movement commands from the first processing device and transmit movement instructions to the mechanical components. It should be noted that, although specific computing hardware is noted above for the first and second computing devices, any type of appropriate computing hardware may be used for any computing device in the AV, including but not limited to a general-purpose computer, a PLC, another programmable logic device (PLD), an application-specific integrated circuit (ASIC), etc. Further, it should be noted that functions, processes, steps, etc. of this disclosure that are carried out by such computing devices may be embodied in any combination of software, digital hardware, and analog hardware. Still further, although two computing devices are explicitly described above, it should be appreciated that the functions, processes, steps, etc. of this disclosure may be carried out by a single computing device, by two computing devices, or by more than two computing devices of the AV. At 602, the cameras are communicatively connected to the computer and when the cameras sense the light, they send the signal via the communication connection to the computer.

At 604, the computer synchronization refers to the idea that multiple processes are to join up or handshake at a certain point, in order to reach an agreement or commit to a certain sequence of action. In this case, the computer synchronizes and combines the pictures of multiple cameras to a single picture.

At 606, the combined picture is encoded into a H.265 video stream with given parameters that will influence the quality and bitrate of the stream. Recent technology known as H.265 (also called HEVC, or High Efficiency Video Coding) is an industry standard for video compression that allows for the recording, compression, and distribution of digital video content. H.265 processes information using coding tree units (CTUs). CTUs process information more efficiently, which results in a smaller file size and less bandwidth used for the video content. It should be noted that viewers with H.265 compatible devices will require less bandwidth and processing power to decompress that data and watch a high-quality stream. Because H.265 compresses video data so much more efficiently, it will drop the bandwidth and storage requirements by roughly 50% compared to previous industry standard H.264.

At 608, the stream is duplicated for redundancy and sent to the router. A router is a device that connects two or more packet-switched networks or subnetworks. It serves two primary functions: managing traffic between these networks by forwarding data packets to their intended IP addresses and allowing multiple devices to use the same Internet connection. There are several types of routers, but most routers pass data between LANs (local area networks) and WANs (wide area networks). Gateways and routers are similar in that they both can be used to regulate traffic between two or more separate networks. However, a regular router is used to join two similar types of networks and a gateway router is used to join two dissimilar networks.

At 610, the router will send the stream over two different modems and providers using 4G/LTE/5G internet connection toward the control station (CS). Modem is a computer hardware device that converts data from a digital format into a format suitable for an analog transmission medium such as telephone. Modems which use a mobile telephone system (4G/LTE) are known as mobile broadband modems.

At 612, both streams are received in the router of an Operating Site (OS) and are routed to a specific control station (CS). The Operating Site (OS) is a place where multiple CSs can be positioned.

At 614, specific control station's (CS) application receives both streams. An application program (software application) is a computer program designed to carry out a specific task other than one relating to the operation of the computer itself, typically to be used by end-users.

At 616, both streams will go through a quality statistics measurement process. The receiver monitors both incoming RTP streams separately, over a set period of time, calculating the packet arrival jitter within one video frame, current video frame arrival rate using the time between the last frame's first packet and the next frame's first packet and the spacing between previous frame's last packet and the next frame's first packet using the timestamps provided by the RTP packet header (see, FIG. 5). There are three separate QoS decisions: increase, reduce, stay. Increase and reduce actions send a command to the sender side to increase or reduce the current video bitrate respectively. The stay action does nothing when the current stream seems stable, and no further actions are needed. Additionally, the QoS mechanism can be triggered asynchronously by the jitter buffer 406 to create a reduce decision in case of packet loss over both RTP streams.

At 618, the streams will be merged by a special process which will also provide some additional statistics about the quality. First of all, determine whether one of the streams' is excellent based on the stream jitter and frame spacing, in this case only one of the streams is deemed stable enough to increase the current bitrate as the stream reliability is high enough that redundancy is not needed in this case.

At 620, quality statistics are merged and evaluated. The receiver determines whether the incoming streams are synchronized to provide redundancy. For this the packet arrival rate is used as the video stream's frames per second is known. If both stream's arrival rate is within the allowed deviation change rate the streams are considered to be synchronized and the algorithm continues with further checks. Otherwise, the reduce QoS action is issued, as a single stream is not reliable enough and the duplicated streams are not providing redundancy. Afterwards both streams' frame spacing is compared against previously predetermined ranges. If both the streams are within acceptable spacing range the increase QoS decision is made. Otherwise, the algorithm falls back to the stay action.

At 622, based on the statistics the bitrate modification message is sent back to the router. At 624, the router will forward the bitrate modification message to the vehicle. At 626, the vehicle's router receives the message over 4G/LTE/5G through antennas and modems. At 628, the router will forward the message to the vehicle's computer. At 630, the computer will modify the encoding bitrate and the process will start from the beginning.

FIG. 7 shows an example, non-limiting, computing environment in which example embodiments and aspects may be implemented. The computing environment is only one example of a suitable computing environment and is not intended to suggest any limitation as to the scope of use or functionality.

Numerous other general purpose or special purpose computing devices environments or configurations may be used, such as, but not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include tangible volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

In one or more implementations, the operational flows of the FIGS. may be implemented in a computing environment such as that shown in FIG. 7. Further, the complex numerical computations to determine quality of service, encode video, and create RTP streams may be performed in a computing environment such as that shown in FIG. 7.

As used herein, the singular form “a,” “an,” and “the” include plural references unless the context clearly dictates otherwise.

As used herein, the terms “can,” “may,” “optionally,” “can optionally,” and “may optionally” are used interchangeably and are meant to include cases in which the condition occurs as well as cases in which the condition does not occur.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

It should be understood that the various techniques described herein may be implemented in connection with hardware components or software components or, where appropriate, with a combination of both. Illustrative types of hardware components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, IoT and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for estimating a quality of service of video streams communicated over a wireless network, comprising:
a sender system that includes a computer, a camera, a video encoder and a router having a plurality of modems; and
a receiver system that includes a computer, a Quality of Service (QOS) estimator, a video decoder, a jitter buffer, and a router,
wherein the sender system communicates video data to the receiver system over the wireless network, and
wherein the QoS estimator monitors the video data for a predetermined period of time to adjust a video bitrate of the video data at the sender system.

2. The system of claim 1, wherein the video data is communicated as redundant RTP video streams.

3. The system of claim 2, wherein an arrival rate of the redundant RTP video streams is within an allowed deviation change rate, the redundant RTP video streams are considered to be synchronized according to the following model to define the deviation change and rate (k),
wherein the deviation change rate is defined as derivative of the packet jitter deviation function ƒ_{deviation}:
$$KPI = \frac{d}{d t} {f}_{deviation} > k .$$

4. The system of claim 2, wherein the receiver system monitors both incoming RTP streams for the predetermined period of time to calculate a packet arrival jitter within one video frame, a current video frame arrival rate using a time between a last frame's first packet and a next frame's first packet, and a spacing between a previous frame's last packet and the next frame's first packet using timestamps provided by the RTP packet header.

5. The system of claim 4, wherein once the predetermined period of time elapses, current values of the packet arrival jitter, the current video frame arrival rate and the spacing are passed to the QoS estimator to make the QoS decision.

6. The system of claim 5, wherein the QoS decision assigns a higher weight to current values of packet arrival jitter, the current video frame arrival rate and the spacing than previously determined values of packet arrival jitter, video frame arrival rate and spacing.

7. The system of claim 5, wherein the QoS decision is one of increasing a video bitrate, decreasing a video bitrate or maintaining a video bitrate at the sender system.

8. The system of claim 7, wherein the sender system adjusts the video bitrate in accordance with instructions communicated by the receiver system.

9. The system of claim 1, wherein the video data is communicated over a mobile wireless network.

10. The system of claim 1, wherein the sender system is an autonomous vehicle.

11. A method for estimating a quality of service of video streams communicated over a wireless network, comprising:
receiving the video streams at a receiver system over a wireless network, wherein the receiver system includes a Quality of Service (QOS) estimator, a video decoder, a jitter buffer, and a router;
monitoring the video streams for a predetermined period of time to make a QoS decision regarding the quality of the video streams;
determining whether to adjust a video bitrate of the video data within the video streams at a sender system; and
communicating the QoS decision to the sender system to adjust the video bitrate communicated over the wireless network.

12. The method of claim 11, further comprising communicating the video data as redundant RTP video streams.

13. The method of claim 12, further comprising:
determining if an arrival rate of the redundant RTP video streams is within an allowed deviation change rate; and
if so, considering the redundant RTP video streams to be synchronized.

14. The method of claim 13, further comprising calculating, by the receiver system, a packet arrival jitter within one video frame, a current video frame arrival rate using a time between a last frame's first packet and a next frame's first packet, and a spacing between a previous frame's last packet and the next frame's first packet using timestamps provided by the RTP packet header.

15. The method of claim 14, further comprising communicating current values of the packet arrival jitter, the current video frame arrival rate and the spacing to the QoS estimator to make the QoS decision after the predetermined period of time elapses.

16. The method of claim 15, further comprising assigning a higher weight to current values of packet arrival jitter, the current video frame arrival rate and the spacing than previously determined values of packet arrival jitter, video frame arrival rate and spacing.

17. The method of claim 15, wherein the QoS decision is one of increasing a video bitrate, decreasing a video bitrate or maintaining a video bitrate at the sender system.

18. The method of claim 11, further comprising adjusting the video bitrate communicated by the sender system in accordance with instructions communicated by the receiver system.

19. The method of claim 11, further comprising communicating the video data over a mobile wireless network.

20. The method of claim 11, wherein the sender system is an autonomous vehicle.
